(19) United States
(12) Patent Application Publication
(10) Pub. No.: US 2019/0086912 A1
(43) Pub. Date: Mar. 21, 2019

(54) METHOD AND SYSTEM FOR GENERATING TWO DIMENSIONAL BARCODE INCLUDING HIDDEN DATA

(71) Applicant: YUAN ZE UNIVERSITY, Taoyuan City (TW)

(72) Inventors: Chia-Yu HSU, New Taipei City (TW); Wei-Chen LIU, Hsinchu City (TW)

(21) Appl. No.: 15/845,177

(22) Filed: Dec. 18, 2017

(30) Foreign Application Priority Data
Sep. 18, 2017 (TW) 106131980

(51) Int. Cl. G05B 23/02; G06N 3/08

(52) U.S. Cl. CPC G05B 23/0281; G06N 3/0436; G05B 23/0278; G06N 3/084

(57) ABSTRACT

A fault detection and classification method of multi-sensors is provided. The method includes the following steps: collecting the plurality of raw sensory data by the plurality of sensors, conducting the data normalization process and data augmentation process by the processor, conducting the feature extraction process by using the convolution neural network having the convolution layer, the activation layer, and the pooling layer, setting a diagnosis layer by connecting the plurality of feature maps to the single neuron, and obtaining the plurality of weight values of the plurality of sensors by using the activation function, and obtaining the abnormal probability by using the calculation of the multilayer perceptron neural network.

### CROSS-REFERENCE TO RELATED APPLICATION

This application claims priority from Taiwan Patent Application No. 106131980, filed on Sep. 18, 2017 at the Taiwan Intellectual Property Office, the content of which is hereby incorporated by reference in its entirety for all purposes.

### BACKGROUND OF THE INVENTION

### 1. Field of the Invention

The present invention relates to a fault detection and classification method of multi-sensors, and is especially related to a fault detection and classification method utilizing multi-sensors, wherein a diagnosis layer including an additional single neuron is designed to analyze abnormality correlation relationships between each of the sensors, such that the results of abnormality classification can further be compared with the status of the sensors.

### 2. Description of the Related Art

With the evolution of the Internet of Things, as well as the “smart factory concept” as described from Industry 4.0, more and more sensors must be used by equipment in a factory to collect and process sensory data for analysis and for monitoring the status of production. This sensory data collected by the sensors is expected to judge or to predict whether the product is abnormal, and, by these means, to adjust the parameters of the equipment, such that traditional factories can progress from the automatic manufacturing to intelligent production. However, as the amount of sensory data gradually increasing, it has become even more important to perform time series analyses on this time-related sensory data. In the current commonly known analysis approach, the time zone for the analysis is defined based on user's experience, and the extremum values or the mean values of the sensory data within the time zone are compared to the default standards, and a warning is issued if these values are out of specification. The subjectively defined zone and the comparison approach may easily miss important information, thereby resulting to poor fault detection and easy misjudgment.

In addition, all components on the equipment or processing steps are highly correlated, and sensory data from different sensors must also be correlated. If data is analyzed from only a single sensor, the correlation between these sensors will be lost, which will in turn, lose the opportunity to predict the occurrences of abnormalities. However, time series analysis on can only be performed by single sensor data using the current analysis techniques. Although the is feature information can be established on the same type of sensors, the correlation between the sensors and the relative importance of the sensors is still unable to be investigated and/or determined. In the semiconductor industry or optoelectronics-related industries, individual product cost is considerable high. If the sensory data cannot provide early detection or prediction of anomalies, and the abnormality can only be found in the final product, the production cost will increase dramatically.

In view of this, the goal that relevant manufacturers want to reach is to establish a deep learning model for multi-sensors, such that the features of sensors can be extracted, and the correlationships between the sensors can be considered, and, therefore, the anomaly detection efficiency and accuracy can be improved. The inventor of the present invention has conceived and designed a fault detection and classification method of multi-sensors to overcome the weaknesses of the current technique and, thus, to promote its utilization in the industry.

### SUMMARY OF THE INVENTION

In view of the aforementioned problems of commonly known technology, the purpose to of the present invention is to provide a fault detection and classification method of multi-sensors to solve the problems of being unable to correctly predict anomalies and being unable to acquire the relative importance of the sensors by the commonly known fault detection and classification method.

According to the purpose of the present invention, provided herein is a fault detection and classification method of multi-sensors, including the following steps: collecting a plurality raw sensory data by a plurality of sensors of a manufacturing apparatus in manufacturing a product in a time series, conducting a data normalization procedure by a processor to transform the sensory dataraw sensory data into a plurality of normalized data, conducting a data augmentation procedure by the processor to transform the plurality of normalized data into a plurality of input data, conducting a feature extraction procedure by the processor by conducting a convolution layer operation of a convolution neural network, a activation layer operation, and a pooling layer operation on the plurality of input data to extract a plurality of feature data, conducting a diagnosis procedure by using a processor through connecting the plurality of feature data to a single neuron and performing a single-perceptron neural network to acquire a plurality of weight values and through a activation function to transform the plurality of weight values into a plurality of correlation weights respectively corresponding to the sensors, and conducting an error detection and classification procedure by the processor through conducting a multilayer perceptron neural network operation on the plurality of weight values to acquire an abnormal probability of the product.

Preferably. the sensory dataraw sensory data can include the pressure value of the apparatus, the flow rate of a gas, the temperature of an apparatus, electrical data, the operational position of the apparatus, or the operational angle of the apparatus.

Preferably, the data normalization procedure is a Z-normalization, which transforms the plurality of sensory data into the plurality of normalized data of which the average is equal to 0 and the standard deviation is equal to 1.

Preferably, the data augmentation procedure uses a sliding window to acquire a plurality of sub-time series from the time series, and the plurality of normalized data corresponding the sub-time series are the plurality of input data.

Preferably, the convolution neural network includes two stages of the convolution layer operation, the activation layer operation, and the pooling layer operation.

Preferably, the activation function includes a sigmoid function, a tanh function, or a ReLU function.

Preferably, the pooling layer operation includes a max pooling approach or a mean pooling approach.

Preferably, the multilayer perceptron neural network operation uses two fully-connected layers to perform the operation, wherein each one of the neurons in an operation layer is connected with all the neurons in the next layer.

Preferably, the multilayer perceptron neural network operation uses a dropout approach, wherein a probability of excluding the operation of a plurality of neurons in a hidden layer is set. The step probability should be 0.5.

As stated above, the method of fault detection and classification of multi-sensors can have one or more of the following advantages:

(1) The method of fault detection and classification of multi-sensors can analyze the full time series and retain the time messages in the data to avoid losing feature information and causing prediction errors if the time range is partially selected, thereby improving the accuracy of the judgement.

(2) The method of fault detection and classification of multi-sensors can process the sensory data of multiple sensors and analyze the correlationships between the sensors and relative importance of the sensors, such that it is helpful to rapidly analyze the cause of an anomaly when it happens and eliminate the anomaly to improve the production yield.

(3) The method of fault detection and classification of multi-sensors can acquire deeper features to more accurately inspect error and anomalies and classify faulty products to avoid unnecessary waste, thereby lowering production cost.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow chart showing a method of fault detection and classification of multi-sensors in an embodiment of the present invention.

FIG. 2 is a schematic diagram showing activation functions in an embodiment of the present invention.

FIG. 3 is a schematic diagram showing a pooling layer operation in an embodiment of the present invention.

FIG. 4 is a schematic diagram showing a diagnosis procedure in an embodiment of the present invention

FIG. 5 is a schematic diagram showing a multilayer perceptron neural network in an embodiment of the present invention.

FIG. 6 is a schematic diagram showing a preprocessing procedure in an embodiment of the present invention.

FIG. 7 is a schematic diagram showing a feature extraction procedure in an embodiment of the present invention.

FIG. 8 is a system architecture diagram of a method of fault detection and classification of multi-sensors in an embodiment of the present invention.

FIG. 9 is a schematic diagram showing a wafer diagnosis output in an embodiment of the present invention.

### DESCRIPTION OF THE PREFERRED EMBODIMENTS

For examiners to better understand the technical features, content, advantage, and effect, the present invention will be presented in detail hereinafter with the help of embodiments and drawings, wherein the purpose of the drawings is to provide assistance to the specification, and the drawings are schematic and do not necessarily imply the actual dimensions or precise configurations of practical implementations of the present invention, and, therefore, the scope of in practices of the present invention is not interpreted and limited by the scale and configuration of the drawings.

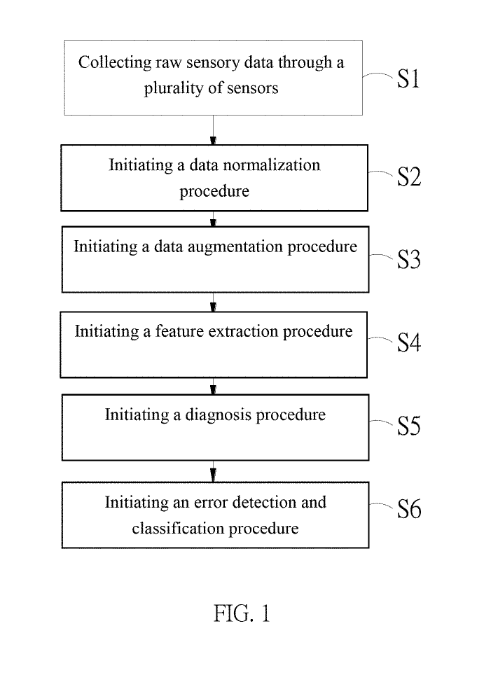

The following refers to FIG. 1, which is a flow chart showing a method of fault detection and classification of multi-sensors in an embodiment of the present invention. As shown in the figure, the method of fault detection and classification of multi-sensors includes the following steps.

A step S1 includes collecting raw sensory data through a plurality of sensors. During the process of manufacturing products, various types of sensors are disposed on the equipment for monitoring manufacturing quality and yield. These sensors collect sensory data from the equipment during a specific time series in the process, e.g. a pressure sensor collecting pressure values of the equipment, a flow meter collecting flow rates of gases, a thermometer collecting temperature of the equipment, a voltmeter and an ammeter collecting electrical data, and tool parameters providing device operational positions and angles. This sensory data in the time series is analyzed in order to identify process abnormalities or to predict and classify the quality of the products. The raw sensory data can be collected by a data collecting device and sent to and saved in a storage device of an analysis computer or a server, and the processor of the computer or the server runs instructions to execute the following steps.

A step S2 includes initiating a data normalization procedure. The raw data collected by the sensors can be transformed into corresponding normalization data by the processor. The reason for performing the normalization procedure is due to the increases in the sensor types and quantities. In this situation, the measuring scale and unit are different for every sensor, and, if the raw sensory data is directly analyzed, the sensory data with high values may overshadow the features from the sensor with low values. Therefore, the raw sensory data has to be normalized first to create an equal analyzing standard for all sensory data.

In the present embodiment, a Z-normalization step can be adopted to normalize the raw sensory data. The transformation formula (1) is shown below:

$${x}_{i}^{′} = \frac{{x}_{i} - μ}{σ} \qquad ( 1 )$$

wherein the time series of the sensory data contain i points in time, and xi is the raw sensory data, and μ is the average of the raw sensory data in the time series, and σ is the standard deviation of the raw sensory data in the time series. According to the previous formula, the raw sensory data is transformed to a normalized data xi′, the average of which is 0 and the standard deviation of which is 1.

A step S3 includes initiating a data augmentation procedure. The normalized sensory data can undergo the data augmentation procedure by using the processor to transform the normalized sensory data into multiple input data. There are two reasons for running the data augmentation procedure. First, because the timing of the occurrence of abnormalities is mostly specific, the processed sensory data of the products is less likely analyzed based on the entire time series, and, moreover, the entire time series analysis not only has a less amount of data but is less capable to reveal a subtle abnormal tendency. Therefore, sliding window partition method is used to extract a plurality of sub-timing series in the present embodiment, and a plurality of normalized data corresponding to the plurality of sub-timing series are the plurality of input data. The time window of the sub-time series can be defined based on the window of the entire time series or based on the data collection time interval of each one of the sensors. For example, if the window of the normalized data of the time series is n and the setup window of sub-timing series is w, the sliding window method can partition the normalized data to acquire n−w+1 sets of input data.

Another reason of running the data augmentation is to avoid the overfitting phenomenon of the following up anomaly detection model establishment. The overfitting phenomenon refers to the model that fits the training data well but fails in practical tests because of too many parameters used in developing the model comparing to the amount of the data acquired. By increasing the amount of data using the data augmentation procedure, the overfitting phenomenon can be avoided. The aforementioned step S2 and step S3 can be regards as steps of preprocessing the raw sensory data, and the data acquired after data normalization and data augmentation is the input of the following feature extraction step.

A step S4 includes initiating a feature extraction procedure. The input data from the preprocessing procedure can be processed by the processor for the feature extraction procedure including conducting a convolution layer operation of a convolution neural network, an activation layer operation, and a pooling layer operation on the input data to extract a plurality of feature data. The following respectively describes the operation of each layer.

First, a post convolution feature data zⱼ^{l} is acquired by adding a bias bⱼ^{l} to a result of a convolution performed between a trained convolution kernel kᵢⱼ^{l} and the feature data xᵢ^{l-1} of the previous layer, as shown in the following Formula (2). The convolution operation to acquire a new feature is by sliding the convolution kernel along the data and performing the inner product between. For the data window n of the sensor data xi and the convolution kernel window w, after the convolution layer operation, the window of the post convolution sensory data will be n−w+1.

zⱼ^{l}=Σᵢxᵢ^{l-1}×kᵢⱼ^{l}+bⱼ^{l} (2)

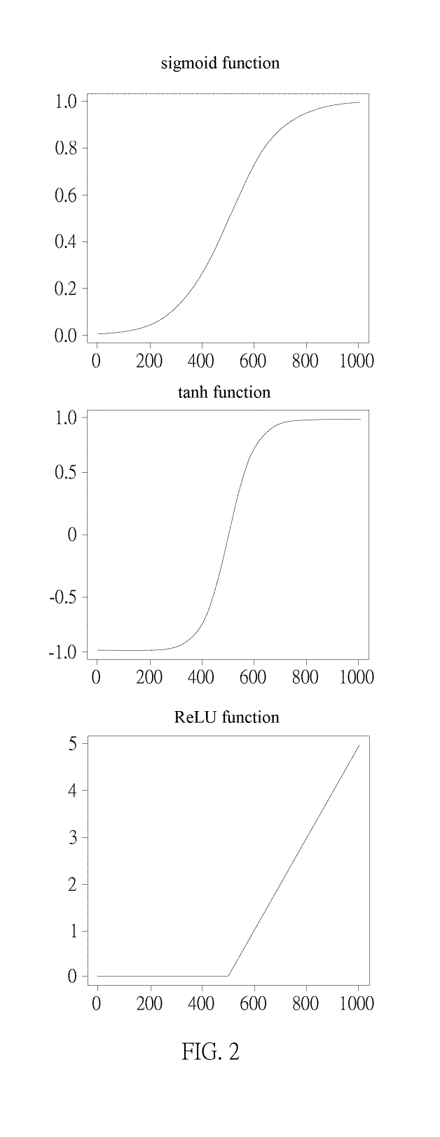

Next, the activation layer uses an activation function f to transform the post convolution feature data zⱼ^{l} from the previous layer to xⱼ^{l}=f(zⱼ^{l}). As the activation function is a nonlinear function, to avoid the output of this layer, there is a linear combination of the input from the previous layer. The commonly known activation functions include a sigmoid function, a tanh function, and a ReLU function. The following refers to FIG. 2, which is a schematic diagram showing the activation functions in an embodiment of the present invention. In the figure, the sigmoid function in Formula (3) has its output mapped between 0 and 1. The tanh function in Formula (4) has its center at 0 and distribution between −1 and 1. ReLU function in Formula (5) has some of its neuron outputs equal to 0.

$$\begin{matrix} sigmoid ( x ) = \frac{1}{1 + {e}^{- x}} & ( 3 ) \\ tanh ( x ) = \frac{2}{1 + {e}^{- 2 x}} - 1 & ( 4 ) \\ ReLU ( x ) = max ( 0 , x ) & ( 5 )\end{matrix}$$

Due to the development of deep learning with more and more hidden layers used, in these activation functions, a sigmoid function and a tanh function may easily have a training problem of vanishing gradient when using a network model to perform backpropagation. Therefore, ReLU is the preferable activation function, in which some of its neuron outputs equal to 0 cause the model sparser, which reduces overfitting phenomenon.

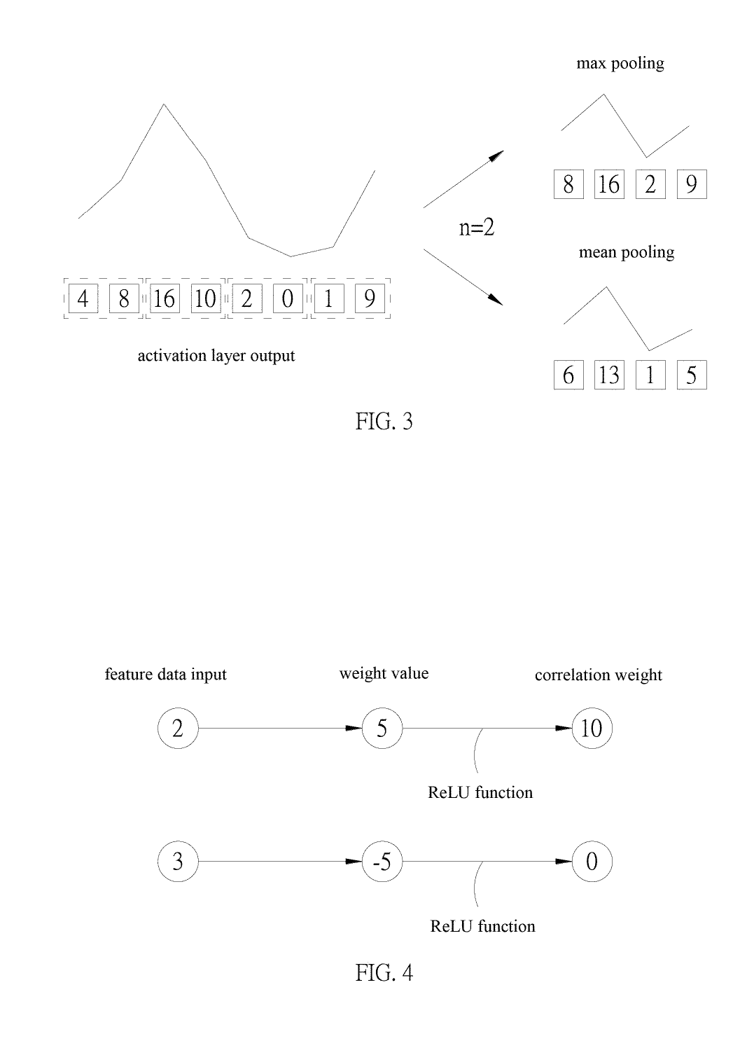

Finally, the pooling layer operation includes a max pooling approach and a mean pooling approach. In the max pooling approach, only the maximum value in each one of feature mappings is returned. In mean pooling, the mean value of each one of feature mappings is returned. Therefore, a new feature is created after performing pooling on the features acquired from the convolution layer and the activation layer. 1×n non-overlapping kernels are used in the pooling layer operation to calculate a maximum or mean value within each kernel, and the data dimensionality of the sensory data is therefore reduced by n times. The following refers to FIG. 3, is a schematic diagram showing a pooling layer operation in an embodiment of the present invention. As shown in the figure, by using a 1×2 kernel to perform pooling operation on the post activation layer output features, feature data of max pooling and mean pooling are respectively created.

The aforementioned feature extraction procedure can include, based on the content of the sensory data, multiple stages of a convolution neural network operation. For example, the input data generated by the preprocessing procedure can go through the convolution layer operation, the activation layer operation, and the pooling layer operation of the step S4 to acquire a first output feature in the first stage, and, then, the first output feature acts as input data for the step S4 and goes through the convolution layer operation, the activation layer operation, and the pooling layer operation again for the second stage to acquire a second out feature, and so on. The number of stages can be user defined. As more stages are applied, features in deeper layers can be found, but longer corresponding operational time is required, thereby reducing analysis efficiency. Therefore, the number of stages for performing the feature extraction should be chosen practically. In the present embodiment, a two stage convolution neural network operation can achieve the best expected result.

A step S5 includes initiating a diagnosis procedure. After finishing the feature extraction on the data of each one of the sensors, a diagnosis layer is initially set up. The structure of the diagnosis layer is a fully-connected layer connecting to a number of single neurons corresponding to the number of sensors. The diagnosis layer outputs the weight value showing differences between sensors. In other words, a single-perceptron neural network acquires multiple weight values output by the diagnosis layer. The multiple weight values are transformed to a plurality of correlation weight values respectively corresponding to the sensors. The following refers to FIG. 4, which is a schematic diagram showing the diagnosis procedure in an embodiment of the present invention. As shown in the figure, the feature data of each sensor acquired by the feature extraction is the input of the diagnosis layer, and the single neurons output the corresponding weight values, e.g. 5 and −5. After the transformation using ReLU activation function, the output correlation weight is 0 for a negative weight value. The correlationship between the weight values indicates the importance. A correlation weight equal to 0 means the corresponding sensor is less important. From the output values of the correlation weights, we can find the relationships between the sensors or the relative importance of the sensory data relationships.

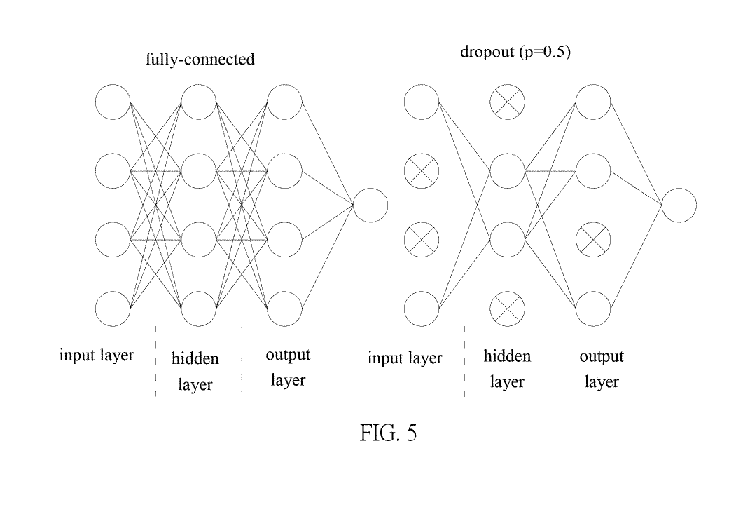

A step S6 includes initiating an error detection and classification procedure. After the diagnosis layer, a plurality of weight values undergoes an operation of a multilayer perceptron neural network by the processor to acquire an abnormal probability of the product. The following refers to FIG. 5, which is a schematic diagram showing the multilayer perceptron neural network in an embodiment of the present invention. In an embodiment as shown in the figure, a fully-connected approach can be used to connect two layers, such that each one of neurons of an operation layer is connected with all the neurons of the next layer to perform the operation. In another embodiment, a dropout approach can be used, wherein a setup probability p can exclude the operation of a plurality of neurons in the hidden layer. The setup probability can be 0.5. The reason for using the dropout approach is similar to the reason of performing the data augmentation in the aforementioned embodiment, wherein the training data may predict a good result, but the test data shows otherwise. To avoid this overfitting phenomenon, the probability of the dropout approach is set to randomly give the neurons in the hidden layer a chance to disappear at each time when each epoch is run to modify the weight values during training. Therefore, when updating the weight values, not every neuron is updated so as to avoid the overfitting phenomenon. In the present embodiment, the error detection and classification model can choose the dropout approach during training and the fully-connected approach in real tests.

The output layer of the multilayer perceptron neural network can use a softmax function to predict classification, as shown in formula below. The formula represents the probability of the prediction result.

$${softmax ( z )}_{j} = \frac{{e}^{{z}_{j}}}{{\sum }_{k = 1}^{K} {e}^{{z}_{k}}} for j = 1 , … , K \qquad ( 6 )$$

Forward propagation and back propagation are used during the calibration. An output value will be acquired after forward propagation, but it is required to use an error function to calculate the error. Since the sensors are used to predict good products and faulty products, cross entropy can be used in this classification topic to calculate error function, as Formula (7) shown below, wherein y is a value of original classification, and y′ is a prediction value.

D(y,y′)=−Σᵢy′ᵢ log(y) (7)

Based on the error function, the weight values connected by the convolution neural network can use a back propagation algorithm and Stochastic gradient descent to modify the parameters of the whole model until the error is converged upon and minimized. Wherein, the technique such as randomly disarranging data sequences can be used to speed up the convergent rate of the neural network. In addition, using all the data to perform training may not only prolong the training time but increase the loading of the memory, and it is difficult to find a learning process that can satisfy all the data. Therefore, a minibatch approach can be used, wherein a mini-batch of data is used and averaged after each epoch to perform the modification.

The following will use CVD (Chemical Vapor Deposition) wafer processing procedure as an example to demonstrate the analysis of sensing parameters collected by the sensors in the apparatus. Wherein, there are 189 wafers, in which 148 wafers are normal and 41 wafers are abnormal. 17 sensors and collected sensory data corresponding to sensing parameters are included in Table 1 for the following procedures.

TABLE 1

| | Sensor parameter |
|---|---|
| Sensor number | explanation |
| 1 | Chamber pressure |
| 2 | Flow rate of gas 1 |
| 3 | Flow rate of gas 3 |
| 4 | Flow rate of gas 4 |
| 5 | Flow rate of gas 5 |
| 6 | Flow rate of gas 7 |
| 7 | Plate heater temperature |
| 8 | Plate heater power input |
| 9 | Plater heater power output |
| 10 | Angle of auto-control |
| | valve |
| 11 | RF power |
| 12 | RF loading position |
| 13 | RF adjustment position |
| 14 | RF Vₚₚ |
| 15 | RF V_{dc} |
| 16 | Nozzle temperature |
| 17 | Nozzle power |

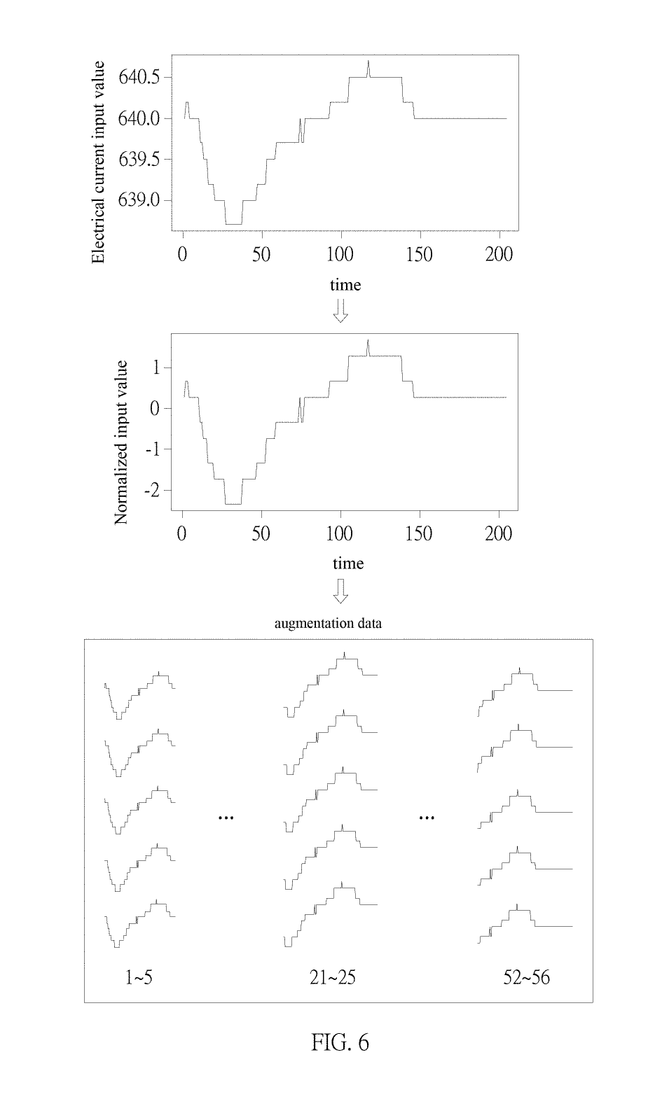

The following refers to FIG. 6, which a schematic diagram showing a preprocessing procedure in an embodiment of the present invention. In the upper part of the figure, the sensory data of the plate heater power input for sensor number 8 is shown as an example. The data collected by the sensor includes the value of the power input from time series 0 to 204, and the values of the raw sensory data fall between 630 to 640. After normalization, the sensory data is transformed to normalized data (its mean value equal to 0 and standard deviation equal to 1). Next, the normalized data undergoes a data augmentation procedure. The time window of the sub-series is set to 149. From time 0, time series is cut by the window with its length equal to 149 to form 56 sub-series. This sub-time series augmentation data acts as the input of the feature extraction. For example, the sub-series 1-5, 21-25, and 52-56 are shown in the lower part of the figure.

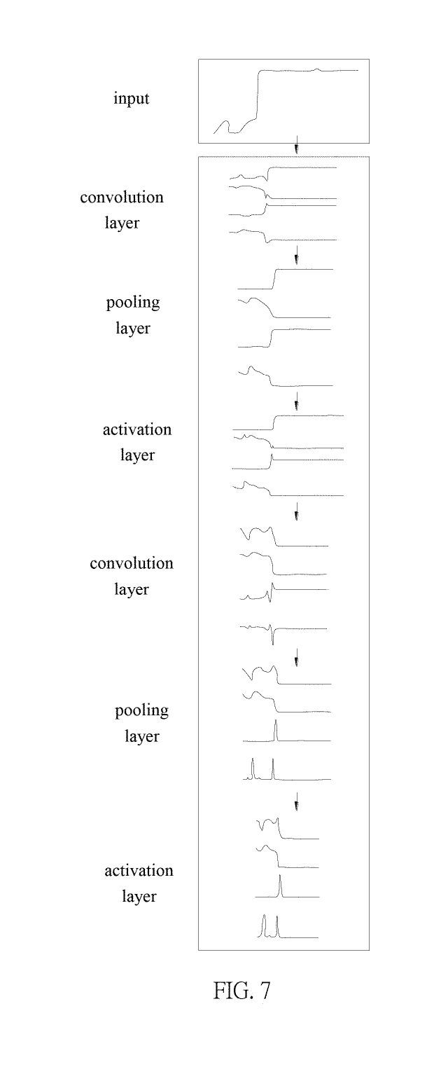

The following refers to FIG. 7, which is a schematic diagram showing a feature extraction procedure in an embodiment of the present invention. As shown in the figure, the input data acquired after the preprocessing procedure undergoes the feature extraction procedure, including a two stage convolution layer operation, an activation layer operation, and a pooling layer operation in the present embodiment. In the convolution layer of the present embodiment, the convolution kernel length of both stages is set to 5, and new feature data C1 and C2 are set to 16 and 24 respectively after data featuring. Although the sensory data of only one sensor is demonstrated in the figure, the convolution layer operation with the same parameter settings can also applied on the other sensors. In the activation layer operation, a sigmoid function, a tanh function, or a ReLU function is used as the activation function. In the pooling layer operation, max pooling and mean pooling are used to reduce the dimension. By inspecting the value of an error function and an error rate of the training data under different settings, a ReLU function and a mean pooling approach are used to minimize the error rate.

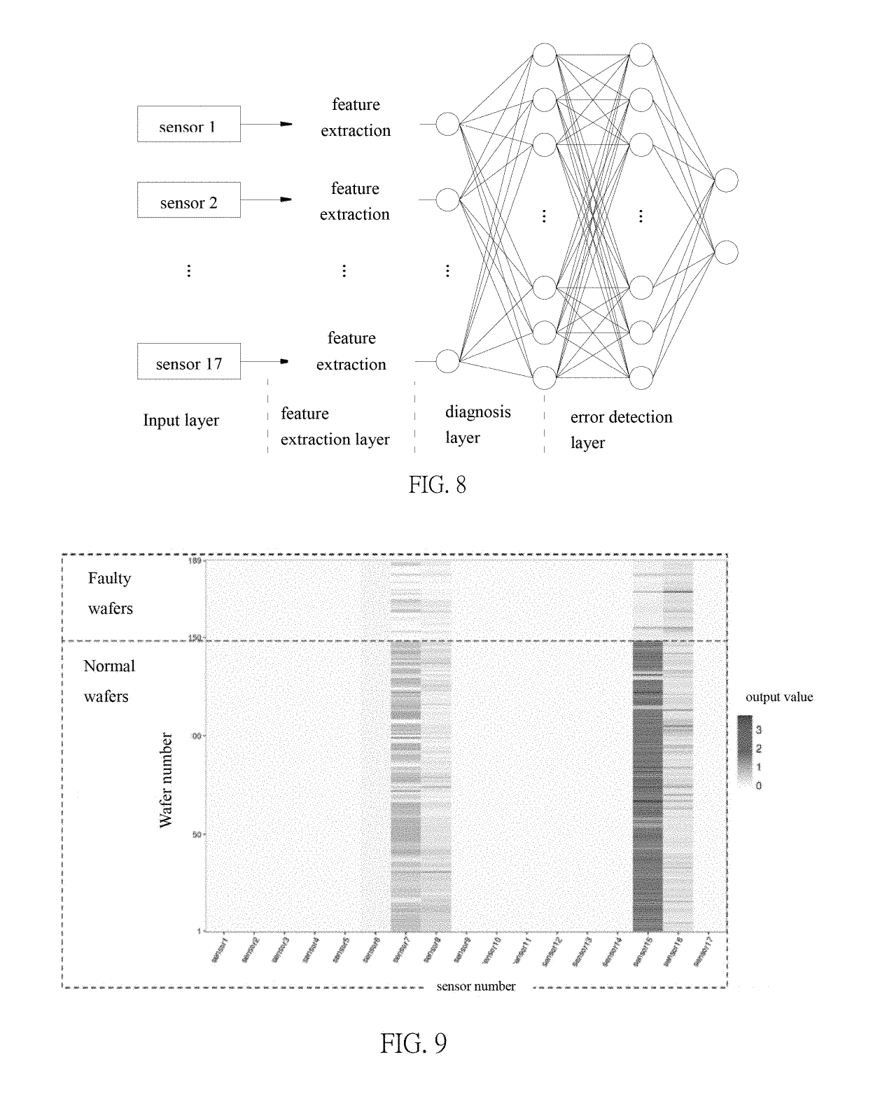

The following refers to FIG. 8, which is a system architecture diagram of a method of fault detection and classification of multi-sensors in an embodiment of the present invention. As shown in the figure, the raw sensory data of the 17 sensors of the input layer undergoes the normalization and data augmentation and the result is the input of the feature extraction layer for the feature extraction, wherein the feature extraction includes the convolution layer operation of the convolution neural network in the previous embodiment, the activation function operation, and the pooling layer operation. By obtaining 256 neurons and using the diagnosis layer with a single neuron, features extracted corresponding to the sensors undergo the design of diagnosis layer and the ReLU activation function, and the output represents the status of each one of the sensors, and also provides the correlation between sensors and relative importance of sensors.

After the diagnosis layer, two fully-connected layers including 732 neurons are established as the hidden layer of the multilayer perceptron neural network. The dropout approach is used during the training, wherein there is a chance that a neuron will not be used to avoid the overfitting phenomenon. Stochastic gradient descent training is also used with learning rate equal to 0.01 and momentum equal to 0.9. A mini-batch with size equal to 128 is used to train the convolution neural network model. The method of 5-fold cross certification is used to evaluate the validity of the error detection and classification in the present embodiment, wherein sensory data of the 189 wafers is equally divided into 5 groups, wherein 4 groups of them are training data and the other is testing data. After the data is divided, the training data is input to the system architecture shown in FIG. 8 to establish the error detection and classification model. Then, the testing data is input to the error detection and classification model to calculate the fuzzy matrix of the testing data. Wherein, the fuzzy matrix includes TP (True positive), which represents the classification result being abnormal and the real result being also abnormal, and FP (False Positive), which represents the classification result being abnormal and the real result being normal, TN (True Negative) represents the classification being not abnormal and the real result being not abnormal, and FN (False Negative), which represents the classification result being not abnormal and the real result being abnormal. The previous classification and real status are used to calculate the precision, the recall rate, and the accuracy to verify the result of the model, as shown in Table 2 below.

TABLE 2

| Fold number | Precision | Recall | Accuracy |
|---|---|---|---|
| 1 | 1.0 | 1.0 | 100% |
| 2 | 1.0 | 0.875 | 97.4% |
| 3 | 1.0 | 1.0 | 100% |
| 4 | 1.0 | 1.0 | 100% |
| 5 | 1.0 | 1.0 | 100% |
| Average | 1.0 | 0.975 | 99.48% |

Wherein, the precision, the recall rate, and the accuracy are calculated following the Formulas (8)-(10) as shown below.

$$\begin{matrix}Precision = \frac{TP}{TP + FP} & ( 8 ) \\ Recall = \frac{TP}{TP + FN} & ( 9 ) \\ Accuracy = \frac{TP + TN}{TP + TN + FP + FN} & ( 10 )\end{matrix}$$

The average of precision values, recall rate values, and the accuracy values in the aforementioned 5-fold cross certification can be the result of the certification in the present embodiment. Compared with the commonly known error detection and classification approach, the model of the present embodiment can accurately detect anomalies on the classification of a good product and a bad product.

The following refers to FIG. 9, which is a schematic diagram showing a wafer diagnosis output in an embodiment of the present invention. For the 189 wafers including the 148 normal wafers and the 41 abnormal wafers, the error detection and classification model established in the present invention can accurately predict the anomaly, based on the certification of the previous embodiment. As for resolving the anomaly, the output of the diagnosis layer can be used to judge and to rapidly eliminate the cause of the anomaly. The configuration of the diagnosis layer including the single neuron can output a weight value corresponding to each one of the sensor weight values, and the weight values are transformed by the activation function such that the output is 0 for those negative weight values, and the output result is shown in FIG. 9. In the figure, sensor 7 and sensor 15 have output values obviously greater than the outputs of other sensors, meaning they have higher correlation and importance than others. When more and more sensors are used, the output sensor correlation weight of the diagnosis layer can quickly to narrow down to the sensor having an anomalous problem, such that it is not required to examine all the sensors. When further comparing the fault diagnosis and the classification result, the problematic sensor and corresponding apparatus can be fixed. For example, the operation can first examine the sensor 7 and the sensor 15 to verify if there is anomaly in the inspection signals, and, then, analyze and examine the corresponding plate heater and RF power to see if there is any anomalous issue so as to find the cause and eliminate it. In another aspect, the threshold value of ReLU activation function can be set to further narrow down the number of possible problematic sensors to improve the analysis efficiency of the sensor diagnosis.

The description above is only for the purpose of illustration but not restriction. Without departing from the spirit of the present application, any equivalent modification or alteration should be considered as falling within the protection scope of the appended claims.

1. A method of fault detection and classification, comprising the steps of:
collecting a plurality of raw sensory data by a plurality of sensors of a manufacturing apparatus in manufacturing a product in a time series;
conducting a data normalization procedure by a processor to transform the raw sensory data into a plurality of normalized data;
conducting a data augmentation procedure by the processor to transform the plurality of normalized data into a plurality of input data;
conducting a feature extraction procedure by the processor through conducting a convolution layer operation of a convolution neural network, an activation layer operation, and a pooling layer operation on the plurality of input data to extract a plurality of feature data;
conducting a diagnosis procedure by the processor through connecting the plurality of feature data to a single neuron and performing a single-perceptron neural network to acquire a plurality of weight values and through an activation function to transform the plurality of weight values into a plurality of correlation weights respectively corresponding to the sensors; and
conducting an error detection and classification procedure by the processor through conducting a multilayer perceptron neural network operation on the plurality of weight values to acquire an abnormal probability of the product.

2. The method of fault detection and classification of claim 1, wherein the raw sensory data comprises a pressure value of the apparatus, a flow rate of a gas, a temperature of the apparatus, an electrical data, an operational position of the apparatus, or an operational angle of the apparatus.

3. The method of fault detection and classification of claim 1, wherein the data normalization procedure is a Z-normalization, which transforms the plurality of sensory data into the plurality of normalized data of which the average is equal to 0 and the standard deviation is equal to 1.

4. The method of fault detection and classification of claim 1, wherein the data augmentation procedure uses a sliding window to acquire a plurality of sub-time series from the time series, and the plurality of normalized data corresponding the sub-time series are the plurality of input data.

5. The method of fault detection and classification of claim 1, wherein the convolution neural network comprises two stages of the convolution layer operation, the activation layer operation, and the pooling layer operation.

6. The method of fault detection and classification of claim 1, wherein the activation function comprises a sigmoid function, a tanh function, or ReLU function.

7. The method of fault detection and classification of claim 1, wherein the pooling layer operation comprises a max pooling approach or a mean pooling approach.

8. The method of fault detection and classification of claim 1, wherein the multilayer perceptron neural network operation uses two fully-connected layers to perform the operation, wherein each one of neurons in an operation layer connects with all neurons in a next layer.

9. The method of fault detection and classification of claim 1, wherein the multilayer perceptron neural network operation uses a dropout approach, wherein a probability of excluding the operation of a plurality of neurons in a hidden layer is set.

10. The method of fault detection and classification of claim 9, wherein the set probability is 0.5.
